(19) United States
(12) Patent Application Publication
(10) Pub. No.: US 2023/0360119 A1
(43) Pub. Date: Nov. 9, 2023

(54) SYSTEM AND METHOD FOR GENERATING GROUPED SHAPLEY VALUES

(71) Applicant: JPMorgan Chase Bank, N.A., New York, NY (US)

(72) Inventors: Daniele MAGAZZENI, London (GB); Jason LONG, Cambridge (GB); Nicolas MARCHESOTTI, London (GB); Emanuele ALBINI, London (GB); Subhashis RAYCHAUDHURI, Bryn Mawr, PA (US); Manuela VELOSO, New York, NY (US); David HEIKE, Toronto (CA); FengQin ZHAO, West Chester, PA (US); Debin QIU, Glen Mills, PA (US)

(73) Assignee: JPMorgan Chase Bank, N.A., New York, NY (US)

(21) Appl. No.: 18/142,309

(22) Filed: May 2, 2023

Related U.S. Application Data
(60) Provisional application No. 63/364,167, filed on May 4, 2022.

(51) Int. Cl. G06Q 40/03

(52) U.S. Cl. CPC G06Q 40/03

(57) ABSTRACT

Various methods, apparatuses/systems, and media for automatically computing grouped Shapley values for action reason codes are disclosed. A processor utilizes a machine learning model that is configured to output decision data; accesses a database that stores the outputted decision data and data corresponding to groups of related features; establishes a communication link between the machine learning model and the database; directly calculates grouped Shapley values that represent mathematically justifiable measure of importance for the groups of related features by implementing a predefined mathematical algorithm; and outputs reason codes based on the computed grouped Shapley values.

### CROSS-REFERENCE TO RELATED APPLICATIONS

This application claims the benefit of priority from U.S. Provisional Patent Application No. 63/364,167, filed May 4, 2022, which is herein incorporated by reference in its entirety.

### TECHNICAL FIELD

This disclosure generally relates to data processing, and, more particularly, to methods and apparatuses for implementing a language and platform agnostic grouped Shapley values generating module for computing grouped Shapley values for positive or negative action reason codes.

### BACKGROUND

The developments described in this section are known to the inventors. However, unless otherwise indicated, it should not be assumed that any of the developments described in this section qualify as prior art merely by virtue of their inclusion in this section, or that those developments are known to a person of ordinary skill in the art.

Adverse (i.e., negative) action reason codes are often used by an organization/firm to provide an explanation to its clients/customers when a machine learning model is used to make a decision with an adverse impact (such as rejecting a credit application, reducing a credit limit, etc., but the disclosure is not limited thereto). The machine learning models used in production are typically highly non-linear, and may include many features, and output decisions based on complex interactions between these features.

In order to reduce the complexity of the explanation for the client/customer, while meeting regulatory requirements as needed, the organization/firm may prefer to specify the “reason codes”, which correspond simply to groups of related features that carry similar information, as applicable.

Shapley values provide a framework with which feature importance can be computed in a mathematically robust way. The widely used SHAP (Shapley Additive explanations) package may provide an efficient implementation for tree-based models to compute the feature importance at the level of individual features. Traditionally, in order to calculate the importance of a reason code, the individual feature importances would be summed within the corresponding group. However, this traditional approach may prove to be inefficient because of the following two main shortcomings among others.

The first shortcoming is that it may be desirable to find the importance of a group of features as a whole, and in general the importance of a group is not equal to the sum of the importances of the constituent features. The latter does not correctly account for the interaction effects between individual features both inside and outside groups. This limitation may prove to be more significant the more interaction effects across features are present in the model interaction effects across features are.

The second shortcoming is that it may be desirable to compute the adverse effect of a group of features, but when simply summing the importances of a group of features, negative importances could cancel out positive importances, and vice versa. This means that the importance of a reason code may not reflect the effective adverse effect that the group of features has on the output of the model. This limitation is more significant the more cancelling effects are happening within the features of each reason code.

Thus, there is a need for an advanced tool that can address these conventional shortcomings.

### SUMMARY

The present disclosure, through one or more of its various aspects, embodiments, and/or specific features or sub-components, provides, among other features, various systems, servers, devices, methods, media, programs, and platforms for implementing a language and platform agnostic as well as model agnostic grouped Shapley values generating module for automatically computing grouped Shapley values whose directions (positive/negative) and values correctly evaluating the contribution of a reason code to the output of a machine learning model, accounting for interactions between features, but the disclosure is not limited thereto. For example, the present disclosure, through one or more of its various aspects, embodiments, and/or specific features or sub-components, provides, among other features, various systems, servers, devices, methods, media, programs, and platforms for implementing a language and platform agnostic grouped Shapley values generating module for reducing the out-of-manifold evaluations of SHAP when features in the same group are highly correlated. In addition, the language and platform agnostic grouped Shapley values generating module may be further configured to report the impact only of features with an adverse impact on the model output, or vice versa, the impact of only features with a beneficial impact on the model output, but the disclosure is not limited thereto.

According to exemplary embodiments, a method for computing grouped Shapley values for action reason codes by utilizing one or more processors along with allocated memory is disclosed. The method may include: utilizing a machine learning model that is configured to output decision data; accessing a database that stores the outputted decision data and data corresponding to groups of related features; establishing a communication link between the machine learning model and the database; directly calculating grouped Shapley values that represent mathematically justifiable measure of importance for the groups of related features by implementing a predefined mathematical algorithm; and outputting reason codes based on the computed grouped Shapley values.

According to exemplary embodiments, the machine learning model may be a tree-based non-linear machine learning model, and in directly calculating the grouped Shapley values, the method may further include: calculating importances of groups of features in polynomial time for the tree-based non-linear machine learning model, but the disclosure is not limited thereto.

According to exemplary embodiments, the machine learning model may be a monotone machine learning model, and in directly calculating the grouped Shapley values, the method may further include: implementing only negative (i.e., beneficial) or positive (i.e., adverse) contributions for the monotone model, but the disclosure is not limited thereto.

According to exemplary embodiments, the monotone model may be built in a manner such that every feature in the model is either positively monotone or negatively monotone.

According to exemplary embodiments, a feature is positively monotone if an increment of a feature, while keeping all other features constant, always gives rise to an output that is greater or equal to that obtained without increasing the feature.

According to exemplary embodiments, a feature is negatively monotone if an increment of a feature, while keeping all other features constant, always gives rise to an output that is lesser or equal to that obtained without increasing the feature.

According to exemplary embodiments, in directly calculating the grouped Shapley values, the method may further include: maintaining links between features within the same reason code, thereby keeping track of which features are in each reason code (i.e., group of features) for which computation of importance in a mathematically sound way is performed.

According to exemplary embodiments, the method may further include: implementing an algorithm to correctly account for interaction effects of the groups of related features; and identifying the most important reason code based on the correctly accounted interaction effects among features in the reason codes.

According to exemplary embodiments, the predefined mathematical algorithm utilizes the following mathematical formula:

$${ϕ}_{j} = {\sum }_{S ⊆ C \backslash {R}_{j}} \frac{\vert S \vert ! ( m - \vert S \vert - 1 ) !}{m !} ( v ( {⋃}_{R ∈ S ⋃ {R}_{j}} R ) - v ( {⋃}_{R ∈ S} R ) ) ,$$

where ϕⱼ represents Shapley values (i.e., the importance) for a group of features Rⱼ corresponding to reason code j, m represents the number of reason codes (i.e., the number of groups of features for which we want to compute the importance), C={R₁, . . . , Rₘ} represents the set of groups of features corresponding to reason codes 1, . . . , m, and v: 2^{N}→ [symbol] represents a characteristic function. The characteristics function v(S) takes as input a set of the features S and returns an estimation of the output of the model when the features not in S are missing. N={1, . . . , n} is the set of features of model f and n represents the number of the features of model f. Our framework to compute grouped Shapley values is agnostic to the choice of characteristics function.

According to exemplary embodiments, a system for computing grouped Shapley values for action reason codes is disclosed. The system may include: a processor; and a memory operatively connected to the processor via a communication interface, the memory storing computer readable instructions, when executed, may cause the processor to: utilize a machine learning model that is configured to output decision data; access a database that stores the outputted decision data and data corresponding to groups of related features; establish a communication link between the machine learning model and the database; directly calculate grouped Shapley values that represent mathematically justifiable measure of importance for the groups of related features by implementing a predefined mathematical algorithm; and output reason codes based on the computed grouped Shapley values.

According to exemplary embodiments, the machine learning model may be a tree-based non-linear machine learning model, and in directly calculating the grouped Shapley values, the processor may be further configured to: calculate importances of groups of features in polynomial time for the tree-based non-linear machine learning model, but the disclosure is not limited thereto.

According to exemplary embodiments, the machine learning model may be a monotone machine learning model, and in directly calculating the grouped Shapley values, the processor may be further configured to: implement only negative (i.e., beneficial) or positive (i.e., adverse) contributions for the monotone model, but the disclosure is not limited thereto.

According to exemplary embodiments, in directly calculating the grouped Shapley values, the processor may be further configured to: maintain links between features within the same reason code, thereby keeping track of which features are in each reason code (i.e., group of features) for which computation of importance in a mathematically sound way is performed.

According to exemplary embodiments, the processor may be further configured to: implement an algorithm to correctly account for interaction effects of the groups of related features; and identify the most important reason code based on the correctly accounted interaction effects among features in the reason codes.

According to exemplary embodiments, a non-transitory computer readable medium configured to store instructions for computing grouped Shapley values for action reason codes is disclosed. The instructions, when executed, may cause a processor to perform the following: utilizing a machine learning model that is configured to output decision data; accessing a database that stores the outputted decision data and data corresponding to groups of related features; establishing a communication link between the machine learning model and the database; directly calculating grouped Shapley values that represent mathematically justifiable measure of importance for the groups of related features by implementing a predefined mathematical algorithm; and outputting reason codes based on the computed grouped Shapley values.

According to exemplary embodiments, the machine learning model may be a tree-based non-linear machine learning model, and in directly calculating the grouped Shapley values, the instructions, when executed, may cause the processor to further perform the following: calculating importances of groups of features in polynomial time for the tree-based non-linear machine learning model, but the disclosure is not limited thereto.

According to exemplary embodiments, the machine learning model may be a monotone machine learning model, and in directly calculating the grouped Shapley values, the instructions, when executed, may cause the processor to further perform the following: implementing only negative (i.e., beneficial) or positive (i.e., adverse) contributions for the monotone model, but the disclosure is not limited thereto.

According to exemplary embodiments, in directly calculating the grouped Shapley values, the instructions, when executed, may cause the processor to further perform the following: maintaining links between features within the same reason code, thereby keeping track of which features are in each reason code (i.e., group of features) for which computation of importance in a mathematically sound way is performed.

According to exemplary embodiments, the instructions, when executed, may cause the processor to further perform the following: implementing an algorithm to correctly account for interaction effects of the groups of related features; and identifying the most important reason code based on the correctly accounted interaction effects among features in the reason codes.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a platform and language agnostic grouped Shapley values generating module for automatically computing grouped Shapley values for negative (i.e., beneficial) or positive (i.e., adverse) action reason codes in accordance with an exemplary embodiment.

FIG. 2 illustrates an exemplary diagram of a network environment with a platform and language agnostic grouped Shapley values generating device in accordance with an exemplary embodiment.

FIG. 3 illustrates a system diagram for implementing a platform and language grouped Shapley values generating device having a platform and language agnostic grouped Shapley values generating module in accordance with an exemplary embodiment.

FIG. 4 illustrates a system diagram for implementing a platform and language agnostic grouped Shapley values generating module of FIG. 3 in accordance with an exemplary embodiment.

FIG. 5 illustrates an exemplary flow chart implemented by the platform and language agnostic grouped Shapley values generating module of FIG. 4 for automatically computing grouped Shapley values for negative (i.e., beneficial) or positive (i.e., adverse) action reason codes in accordance with an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

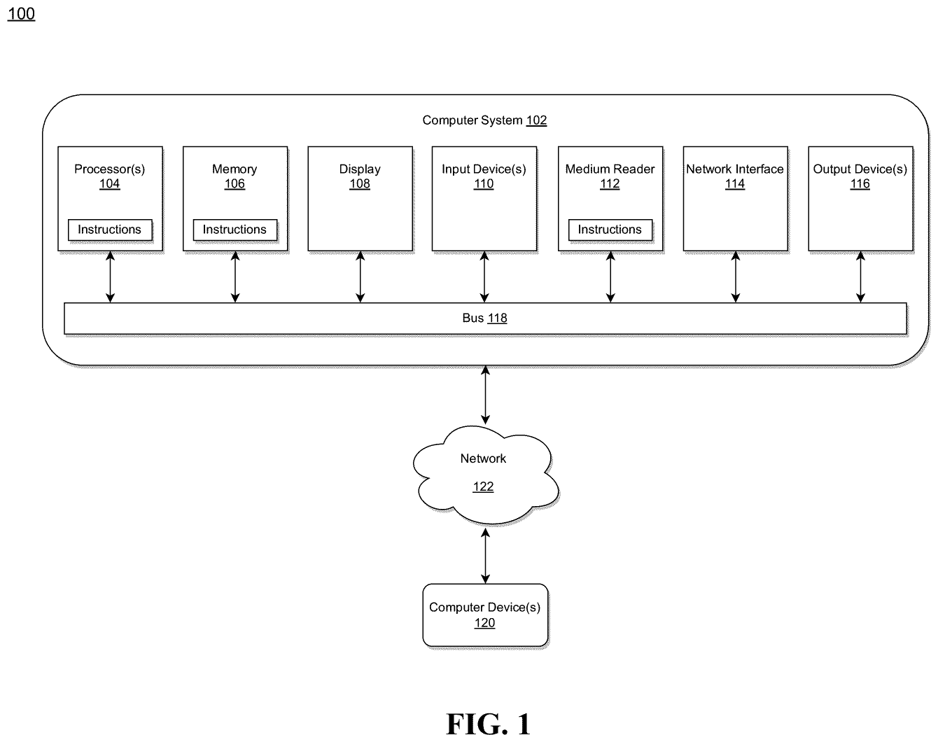

FIG. 1 is an exemplary system 100 for use in implementing a platform and language agnostic grouped Shapley values generating module that may be configured for automatically computing grouped Shapley values for negative (i.e., beneficial) or positive (i.e., adverse) action reason codes, in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

According to exemplary embodiments, the grouped Shapley values generating module may be platform and language agnostic as well as model agnostic that may allow for consistent easy orchestration and passing of data through various components to output a desired result. Since the disclosed process, according to exemplary embodiments, is platform and language agnostic as well as model agnostic, the grouped Shapley values generating module may be independently tuned or modified for optimal performance without affecting the configuration or data files. The configuration or data files, according to exemplary embodiments, may be written using JSON, but the disclosure is not limited thereto. For example, the configuration or data files may easily be extended to other readable file formats such as XML, YAML, etc., or any other configuration based languages.

In accordance with various embodiments of the present disclosure, the methods described herein may be implemented using a hardware computer system that executes software programs. Further, in an exemplary, non-limited embodiment, implementations can include distributed processing, component/object distributed processing, and an operation mode having parallel processing capabilities. Virtual computer system processing can be constructed to implement one or more of the methods or functionality as described herein, and a processor described herein may be used to support a virtual processing environment.

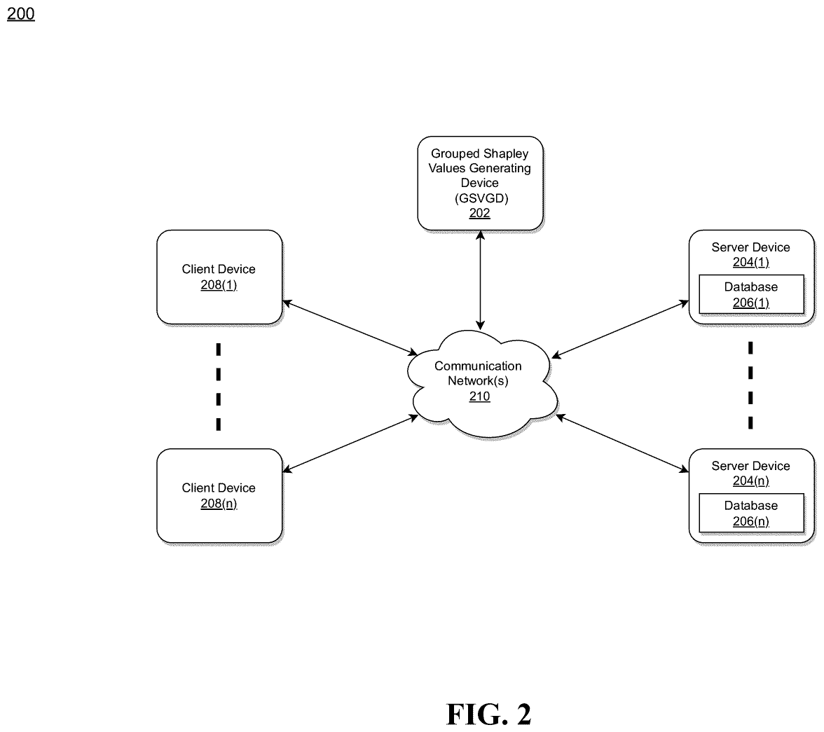

Referring to FIG. 2, a schematic of an exemplary network environment 200 for implementing a platform and language agnostic grouped Shapley values generating device (GSVGD) of the instant disclosure is illustrated.

According to exemplary embodiments, the above-described problems associated with conventional tools may be overcome by implementing an GSVGD 202 as illustrated in FIG. 2 that may be configured for automatically computing grouped Shapley values whose directions (positive/negative) and values correctly evaluating the contribution of a reason code to the output of a machine learning model, accounting for interactions between features, but the disclosure is not limited thereto.

The GSVGD 202 may be the same or similar to the computer system 102 as described with respect to FIG. 1.

The GSVGD 202 may store one or more applications that can include executable instructions that, when executed by the GSVGD 202, cause the GSVGD 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the GSVGD 202 itself, may be located in virtual server(s) running in a cloud-based computing environment rather than being tied to one or more specific physical network computing devices. Also, the application(s) may be running in one or more virtual machines (VMs) executing on the GSVGD 202. Additionally, in one or more embodiments of this technology, virtual machine(s) running on the GSVGD 202 may be managed or supervised by a hypervisor.

In the network environment 200 of FIG. 2, the GSVGD 202 is coupled to a plurality of server devices 204(1)-204(n) that hosts a plurality of databases 206(1)-206(n), and also to a plurality of client devices 208(1)-208(n) via communication network(s) 210. A communication interface of the GSVGD 202, such as the network interface 114 of the computer system 102 of FIG. 1, operatively couples and communicates between the GSVGD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the GSVGD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The GSVGD 202 may be a standalone device or integrated with one or more other devices or apparatuses, such as one or more of the server devices 204(1)-204(n), for example. In one particular example, the GSVGD 202 may be hosted by one of the server devices 204(1)-204(n), and other arrangements are also possible. Moreover, one or more of the devices of the GSVGD 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the GSVGD 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

According to exemplary embodiments, the client devices 208(1)-208(n) in this example may include any type of computing device that can facilitate the implementation of the GSVGD 202 that may efficiently provide a platform for implementing a platform and language agnostic grouped Shapley values generating module for automatically computing grouped Shapley values whose directions (positive/negative) and values correctly evaluating the contribution of a reason code to the output of a machine learning model, accounting for interactions between features, but the disclosure is not limited thereto.

The client devices 208(1)-208(n) may run interface applications, such as standard web browsers or standalone client applications, which may provide an interface to communicate with the GSVGD 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the GSVGD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the GSVGD 202, the server devices 204(1)-204(n), or the client devices 208(1)-208(n), for example, may be configured to operate as virtual instances on the same physical machine. For example, one or more of the GSVGD 202, the server devices 204(1)-204(n), or the client devices 208(1)-208(n) may operate on the same physical device rather than as separate devices communicating through communication network(s) 210. Additionally, there may be more or fewer GSVGDs 202, server devices 204(1)-204(n), or client devices 208(1)-208(n) than illustrated in FIG. 2. According to exemplary embodiments, the GSVGD 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

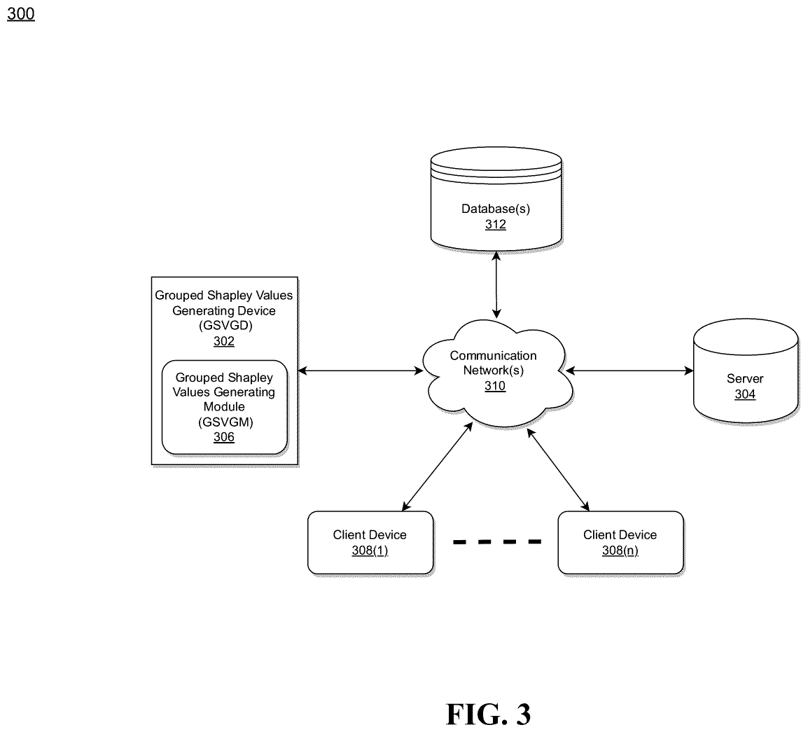

FIG. 3 illustrates a system diagram for implementing an GSVGD having a platform and language agnostic grouped Shapley values generating module (GSVGM) in accordance with an exemplary embodiment.

As illustrated in FIG. 3, the system 300 may include a GSVGD 302 within which an GSVGM 306 is embedded, a server 304, a database(s) 312, a plurality of client devices 308(1) . . . 308(n), and a communication network 310.

According to exemplary embodiments, the GSVGD 302 including the GSVGM 306 may be connected to the server 304, and the database(s) 312 via the communication network 310. The GSVGD 302 may also be connected to the plurality of client devices 308(1) . . . 308(n) via the communication network 310, but the disclosure is not limited thereto.

According to exemplary embodiment, the GSVGD 302 is described and shown in FIG. 3 as including the GSVGM 306, although it may include other rules, policies, modules, databases, or applications, for example. According to exemplary embodiments, the database(s) 312 may be configured to store output decision data outputted from a machine learning model and data corresponding to groups of related features. Although only one database is illustrated in FIG. 3, the disclosure is not limited thereto. Any number of desired databases may be utilized for use in the disclosed invention herein. The database(s) 312 may be a mainframe database, a log database that may produce programming for searching, monitoring, and analyzing machine-generated data via a web interface, etc., but the disclosure is not limited thereto.

According to exemplary embodiments, the GSVGM 306 may be configured to receive real-time feed of data from the plurality of client devices 308(1) . . . 308(n) via the communication network 310.

According to exemplary embodiments, first, the GSVGM 306 utilizes a machine learning model (that is already trained; or alternatively trained by the GSVGM 306). The machine learning model, given a sample (or a set of samples), outputs decision data. For example, the machine learning model may return a score/prediction on the, for example, probability of default of a client (this is its output).

According to exemplary embodiments, the method implemented by the GSVGM 306 then explains that decision data outputted by the machine learning model. For example, the GSVGM 306 explains which groups of features (also called reason codes) are the main drivers of the adverse decision of the model. It does so by providing an importance for each reason code (a positive or negative number).

Therefore, the GSVGM 306 is configured to compute the Shapley values of groups of features in a mathematically sound way. This can be done either in a model-agnostic way (for any kind of model), or in even more efficient way for tree-based models (i.e., the computation can be done in polynomial time). Optionally, the GSVGM 306 may cause the database(s) 312 to store the importance of each reason code (i.e., group of features) for a single or multiple samples.

As will be described below, the GSVGM 306 may be configured to: utilize a machine learning model that is configured to output decision data; access the database(s) 312 that stores the output decision data and data corresponding to groups of related features; establish a communication link between the machine learning model and the database(s) 312; directly calculate grouped Shapley values that represent mathematically justifiable measure of importance for the groups of related features by implementing a predefined mathematical algorithm; and output reason codes based on the computed grouped Shapley values, but the disclosure is not limited thereto.

The plurality of client devices 308(1) . . . 308(n) are illustrated as being in communication with the GSVGD 302. In this regard, the plurality of client devices 308(1) . . . 308(n) may be “clients” (e.g., customers) of the GSVGD 302 and are described herein as such. Nevertheless, it is to be known and understood that the plurality of client devices 308(1) . . . 308(n) need not necessarily be “clients” of the GSVGD 302, or any entity described in association therewith herein. Any additional or alternative relationship may exist between either or both of the plurality of client devices 308(1) . . . 308(n) and the GSVGD 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. According to exemplary embodiments, the server 304 may be the same or equivalent to the server device 204 as illustrated in FIG. 2.

The process may be executed via the communication network 310, which may comprise plural networks as described above. For example, in an exemplary embodiment, one or more of the plurality of client devices 308(1) . . . 308(n) may communicate with the GSVGD 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The GSVGD 302 may be the same or similar to the GSVGD 202 as described with respect to FIG. 2, including any features or combination of features described with respect thereto.

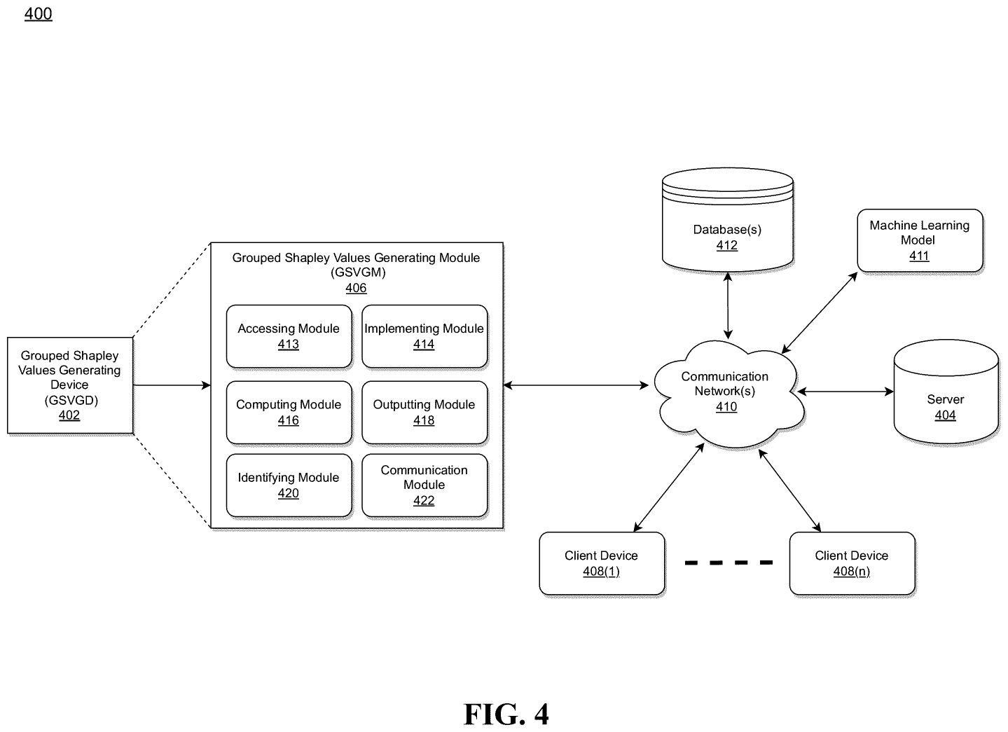

FIG. 4 illustrates a system diagram for implementing a GSVGM of FIG. 3 in accordance with an exemplary embodiment.

According to exemplary embodiments, the system 400 may include a platform and language agnostic GSVGD 402 within which a platform and language agnostic GSVGM 406 is embedded, a server 404, a machine learning model 411, database(s) 412, and a communication network 410.

According to exemplary embodiments, the GSVGD 402 including the GSVGM 406 may be connected to the server 404, the machine learning model 411, and the database(s) 412 via the communication network 410. The GSVGD 402 may also be connected to the plurality of client devices 408(1)-408(n) via the communication network 410, but the disclosure is not limited thereto. The GSVGM 406, the server 404, the plurality of client devices 408(1)-408(n), the database(s) 412, the communication network 410 as illustrated in FIG. 4 may be the same or similar to the GSVGM 306, the server 304, the plurality of client devices 308(1)-308(n), the database(s) 312, the communication network 310, respectively, as illustrated in FIG. 3.

According to exemplary embodiments, as illustrated in FIG. 4, the GSVGM 406 may include an accessing module 413, an implementing module 414, a computing module 416, an outputting module 418, an identifying module 420, and a communication module 422.

According to exemplary embodiments, each of the accessing module 413, implementing module 414, computing module 416, outputting module 418, identifying module 420, and the communication module 422 of the GSVGM 406 may be physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies.

According to exemplary embodiments, each of the accessing module 413, implementing module 414, computing module 416, outputting module 418, identifying module 420, and the communication module 422 of the GSVGM 406 may be implemented by microprocessors or similar, and may be programmed using software (e.g., microcode) to perform various functions discussed herein and may optionally be driven by firmware and/or software.

Alternatively, according to exemplary embodiments, each of the accessing module 413, implementing module 414, computing module 416, outputting module 418, identifying module 420, and the communication module 422 of the GSVGM 406 may be implemented by dedicated hardware, or as a combination of dedicated hardware to perform some functions and a processor (e.g., one or more programmed microprocessors and associated circuitry) to perform other functions.

According to exemplary embodiments, each of the accessing module 413, implementing module 414, computing module 416, outputting module 418, identifying module 420, and the communication module 422 of the GSVGM 406 may be called via corresponding API.

The process may be executed via the communication module 422 and the communication network 410, which may comprise plural networks as described above. For example, in an exemplary embodiment, the various components of the GSVGM 406 may communicate with the server 404, the machine learning model 411, and the database(s) 412 via the communication module 422 and the communication network 410. Of course, these embodiments are merely exemplary and are not limiting or exhaustive.

According to exemplary embodiments, the machine learning model 411 may output decision data. The database(s) may be configured to store the decision data outputted by the machine learning model 411 and data corresponding to groups of related features. The communication module 422 may be configured to establish a communication link between the machine learning model 411 and the database(s) 412.

According to exemplary embodiments, the accessing module 413 may be configured to access the database(s) 412 that stores the outputted decision data and the data corresponding to groups of related features.

According to exemplary embodiments, the computing module 416 may be configured to directly calculate grouped Shapley values that represent mathematically justifiable measure of importance for the groups of related features by implementing a predefined mathematical algorithm. According to exemplary embodiments, the outputting module 418 may be configured to output reason codes based on the computed grouped Shapley values.

According to exemplary embodiments, the machine learning model 411 may be a tree-based non-linear machine learning model, and in directly calculating the grouped Shapley values, the computing module 416 may be configured to calculate importances of groups of features in polynomial time for the tree-based non-linear machine learning model, but the disclosure is not limited thereto.

According to exemplary embodiments, the machine learning model 411 may be a monotone machine learning model, and in directly calculating the grouped Shapley values, the implementing module 414 may be configured to implement only negative (i.e., beneficial) or positive (i.e., adverse) contributions for the monotone model, but the disclosure is not limited thereto.

According to exemplary embodiments, in directly computing the grouped Shapley values, the communication module 422 may be configured to maintain links between features within the same reason code, thereby keeping track of which features are in each reason code (i.e., group of features) for which computation of importance in a mathematically sound way is performed.

According to exemplary embodiments, the implementing module 414 may be further configured to implement an algorithm to correctly account for interaction effects of the groups of related features. The identifying module 420 may be configured to identify the most important reason code based on the correctly accounted interaction effects among features in the reason codes.

The GSVGM 406, according to exemplary embodiments may be configured to formulate an approach for directly calculating the mathematically justifiable measure of importance for groups of features. Conventionally, in SHAP, features are ‘turned on and off’ individually when measuring their contribution to the output of the model. Instead, according to exemplary embodiments, the GSVGM 406 may be configured to “turn on or off” the features in the same group all together.

For example, given a model f, a set of features N of size n, a background distribution D and an input x we know that the Shapley value ϕᵢ of a group of features (i.e., a reason code) j is traditionally calculated by summing the Shapley values of each feature in the group as follows.

$${ϕ}_{j} = {\sum }_{i ∈ {R}_{j}} {\sum }_{S ⊆ N \backslash \{ i \}} \frac{\vert S \vert ! ( n - \vert S \vert - 1 ) !}{n !} ( v ( S ⋃ \{ i \} ) - v ( S ) )$$

With v(S)=E_{x′·D}[f(x_{S}, x′_{N\S})] and where with an abuse of notation, given a partition of the feature set N in two sets S and T f(x_{S}, x′_{T}) is the output of model f for input x where features T of x are imputed with those of x′. However, the disclosure is not limited thereto. According to exemplary embodiments, the process disclosed herein is agnostic to the choice of characteristics function. This exemplary use case of the particular characteristics function may only be necessary/used in an efficient implementation of the technique for tree-based models.

Instead of the above method, according to exemplary embodiments, the predefined mathematical algorithm utilizes the following mathematical formula which utilizes groups of features:

$${ϕ}_{j} = {\sum }_{S ⊆ C \backslash {R}_{j}} \frac{\vert S \vert ! ( m - \vert S \vert - 1 ) !}{m !} ( v ( {⋃}_{R ∈ S ⋃ {R}_{j}} R ) - v ( {⋃}_{R ∈ S} R ) ) ,$$

where ϕⱼ represents Shapley values for a group of features Rⱼ, m represents reason codes, C={R₁, . . . , Rₘ} represents corresponding set of groups of features corresponding to reason codes, and v represents characteristic function as disclosed above.

According to exemplary embodiments, the GSVGM 406 may also be configured to implement a process that allows for alternative approaches for measuring importance. For example, the process implemented by the GSVGM 406 may include a variant which measures only the impact of features with an adverse impact to the model score under certain assumptions.

According to exemplary embodiments, the GSVGM 406 may also be configured to implement a process that allows for alternative approaches for measuring importance. For example, the process implemented by the GSVGM 406 may include a variant which measures only the impact of features with a beneficial impact or adverse impact to the model score under certain assumptions.

For example, if the machine learning model 411 is monotone, then the GSVGM 406 can ‘turn off’ the computation of the Shapley values for all the features whose contributions act to decrease (or conversely, increase) the model score. According to exemplary embodiments, the monotone model may be built in a manner such that every feature in the model is either positively monotone or negatively monotone. According to exemplary embodiments, a feature is positively monotone if an increment of a feature, while keeping all other features constant, always gives rise to an output that is greater or equal to that obtained without increasing the feature. According to exemplary embodiments, a feature is negatively monotone if an increment of a feature, while keeping all other features constant, always gives rise to an output that is lesser or equal to that obtained without increasing the feature.

For example, given a model f, a set of features N and a partition of the features N in positively and negatively monotone features P={Pos, Neg}, i.e., P is such that Pos∪Neg=N and Pos∩Neg=ø, then we propose to compute the positive grouped Shapley value for a group of features Rⱼ as above but changing the characteristic function v as follows: v(S)=E_{x′·D}[f(x_{S∪K(x,x′)}, x′_{N(S∪K(x,x′))})], where K(x, x′)={i∈Pos:xᵢ<x′ᵢ}∪{i∈Neg:xᵢ>xᵢ′} and with an abuse of notation, given a partition of the feature in two sets S and T f(x_{S},x′_{T}) is the model output for x where features T of x are imputed with those of x′.

For example, given a model f, a set of features N and a partition of the features N in positively and negatively monotone features P={Pos, Neg}, i.e., P is such that Pos∪Neg=N and PosΩNeg=ø, then we propose to compute the negative grouped Shapley value (or alternatively, positive grouped Shapley value) for a group of features Rⱼ as above but changing the characteristic function v as follows:v(S)=E_{x′˜D}[f(x_{S∪K(x,x′)}, x′_{N(S∪K(x,x′))})], where K(x, x′)={i∈Pos:xᵢ>x′ᵢ}∪{i∈Neg:xᵢ<xᵢ′} and with an abuse of notation, given a partition of the feature in two sets S and T f(x_{S},x′_{T}) is the model output for x where features T of x are imputed with those of x′.

According to exemplary embodiments, reason codes may refer to grouping similar features together so that explanations for clients/customers are not too technical. For example, reason code “balance” may represent the following grouped features: balance on credit cards, balance on mortgages, balance on other loans, etc., but the disclosure is not limited thereto. For example, reason code “delinquency” may represent the following grouped features: amount past due on credit cards; amount now past due on outstanding car loan, etc., but the disclosure is not limited thereto. For example, reason code “utilization” may represent the following grouped features: ratio between cards balance and credit limit; number of active credit cards, etc., but the disclosure is not limited thereto.

SHAP gives importance values for the raw features used by the model. However, today, there is no tool that can combine these raw features so that the most informative reason codes can be transmitted to the clients/customers. Conventional tool simply adds up the individual feature contributions. For example, conventional tool may compute “balance” reason code importances to be +0.23 by adding following SHAP values: +0.10 (credit card balance); +0.06 (balance on mortgages); and +0.07 (balance on other loans)). Conventional tool may compute “delinquency” reason code importances to be +0.24 by adding following SHAP values: +0.16 (amount past due on credit cards); and +0.08 (amount now past due on outstanding car loan). Conventional tool may compute “utilization” reason code importances to be +0.12 by adding following SHAP values: +0.07 (number of active credit cards); and +0.05 (ratio between cards balance and credit limit).

However, in contrast to conventional tools, according to exemplary embodiments, the GSVGM 406 may be configured to modify the SHAP framework to directly handle groups of raw features under mild assumptions. For example, the GSVGM 406 may generate reason code importances for grouped SHAP. According to exemplary embodiments, reason code importances for “balance” can be computed as +0.30 for the grouped SHAP features: balance on credit cards, balance on mortgages and balance on other loans. According to exemplary embodiments, reason code importances for “delinquency” can be computed as +0.18 for the grouped SHAP features: amount past due on credit cards and amount now past due on outstanding car loan. According to exemplary embodiments, reason code importances for “utilization” can be computed as +0.12 for the grouped SHAP features: ratio between cards balance and credit limit and number of active credit cardsThus, when correctly accounting for interaction effects one can easily see the balance reason code is in fact the most important.

According to exemplary embodiments, the GSVGM 406 may be configured to output grouped SHAP for reason codes. Grouped SHAP, according to exemplary embodiments, builds on a TreeSHAP algorithm by including functionality for: directly calculating the importances of groups of feature: performing the above method in polynomial time for tree-based models; and including the option to consider only positive or negative contributions for monotone models, but the disclosure is not limited thereto.

Thus, according to exemplary embodiments, the process can be implemented by the GSVGM 406 in runtime in line with business requirements. According to exemplary embodiments, the above process implemented by the GSVGM 406 can be utilized in many business use-cases since it is applicable to any tree-based model with reason code explanations.

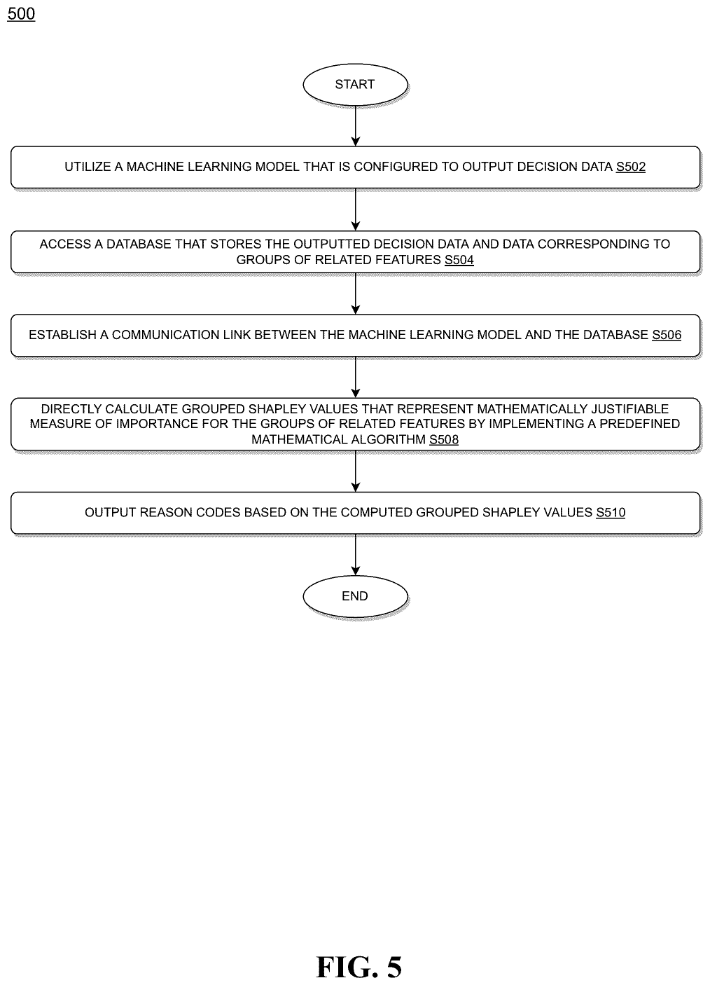

FIG. 5 illustrates an exemplary flow chart of a process 500 implemented by the GSVGM 405 of FIG. 4 for automatically computing grouped Shapley values for negative (i.e., beneficial) or positive (i.e., adverse) action reason codes in accordance with an exemplary embodiment. It will be appreciated that the illustrated process 500 and associated steps may be performed in a different order, with illustrated steps omitted, with additional steps added, or with a combination of reordered, combined, omitted, or additional steps.

As illustrated in FIG. 5, at step S502, the process 500 may include utilizing a machine learning model that is configured to output decision data.

At step S504, the process 500 may include accessing a database that stores the outputted decision data and data corresponding to groups of related features.

At step S506, the process 500 may include establishing a communication link between the machine learning model and the database.

At step S508, the process 500 may include directly calculating grouped Shapley values that represents mathematically justifiable measure of importance for the groups of related features by implementing a predefined mathematical algorithm.

At step S510, the process 500 may include outputting reason codes based on the computed grouped Shapley values.

According to exemplary embodiments, the machine learning model may be a tree-based non-linear machine learning model, and in directly calculating the grouped Shapley values, the process 500 may further include: calculating importances of groups of features in polynomial time for the tree-based non-linear machine learning model, but the disclosure is not limited thereto.

According to exemplary embodiments, the machine learning model may be a monotone machine learning model, and in directly calculating the grouped Shapley values, the process 500 may further include: implementing only negative (i.e., beneficial) or positive (i.e., adverse) contributions for the monotone model, but the disclosure is not limited thereto.

According to exemplary embodiments, in the process 500, the monotone model may be built in a manner such that every feature in the model is either positively monotone or negatively monotone.

According to exemplary embodiments, in the process 500, a feature is positively monotone if an increment of a feature, while keeping all other features constant, always gives rise to an output that is greater or equal to that obtained without increasing the feature.

According to exemplary embodiments, in the process 500, a feature is negatively monotone if an increment of a feature, while keeping all other features constant, always gives rise to an output that is lesser or equal to that obtained without increasing the feature.

According to exemplary embodiments, in directly calculating the grouped Shapley values, the process 500 may further include: maintaining links between features within the same reason code, thereby keeping track of which features are in each reason code (i.e., group of features) for which computation of importance in a mathematically sound way is performed.

According to exemplary embodiments, the process 500 may further include: implementing an algorithm to correctly account for interaction effects of the groups of related features; and identifying the most important reason code based on the correctly accounted interaction effects among the features in the reason codes.

According to exemplary embodiments, in the process 500, the predefined mathematical algorithm utilizes the following mathematical formula:

$${ϕ}_{j} = {\sum }_{S ⊆ C \backslash {R}_{j}} \frac{\vert S \vert ! ( m - \vert S \vert - 1 ) !}{m !} ( v ( {⋃}_{R ∈ S ⋃ {R}_{j}} R ) - v ( {⋃}_{R ∈ S} R ) ) ,$$

where ϕⱼ represents Shapley values (i.e., the importance) for a group of features Rⱼ corresponding to reason code j, m represents the number of reason codes (i.e., the number of groups of features for which we want to compute the importance), C={R₁, . . . , Rₘ} represents the set of groups of features corresponding to reason codes 1, . . . , m, and v: 2^{N}→ [symbol] represents a characteristic function. The characteristics function v(S) takes as input a set of the features S and returns an estimation of the output of the model when the features not in S are missing. N={1, . . . , n} is the set of features of model f and n represents the number of the features of model f. Our framework to compute grouped Shapley values is agnostic to the choice of characteristics function.

According to exemplary embodiments, the GSVGD 402 may include a memory (e.g., a memory 106 as illustrated in FIG. 1) which may be a non-transitory computer readable medium that may be configured to store instructions for implementing a GSVGM 406 for computing grouped Shapley values for negative (i.e., beneficial) or positive (i.e., adverse) action reason codes as disclosed herein. The GSVGD 402 may also include a medium reader (e.g., a medium reader 112 as illustrated in FIG. 1) which may be configured to read any one or more sets of instructions, e.g., software, from any of the memories described herein. The instructions, when executed by a processor embedded within the GSVGM 406 or within the GSVGD 402, may be used to perform one or more of the methods and processes as described herein. In a particular embodiment, the instructions may reside completely, or at least partially, within the memory 106, the medium reader 112, and/or the processor 104 (see FIG. 1) during execution by the GSVGD 402.

According to exemplary embodiments, the instructions, when executed, may cause a processor embedded within the GSVGM 406 or the GSVGD 402 to perform the following: utilizing a machine learning model that is configured to output decision data; accessing a database that stores the outputted decision data and data corresponding to groups of related features; establishing a communication link between the machine learning model and the database; directly calculating grouped Shapley values that represent mathematically justifiable measure of importance for the groups of related features by implementing a predefined mathematical algorithm; and outputting reason codes based on the computed grouped Shapley values. According to exemplary embodiments, the processor may be the same or similar to the processor 104 as illustrated in FIG. 1 or the processor embedded within GSVGD 202, GSVGD 302, GSVGD 402, and GSVGM 406.

According to exemplary embodiments, the machine learning model may be a tree-based non-linear machine learning model, and in directly calculating the grouped Shapley values, the instructions, when executed may further cause the processor 104 to perform the following: calculating importances of groups of features in polynomial time for the tree-based non-linear machine learning model, but the disclosure is not limited thereto.

According to exemplary embodiments, the machine learning model may be a monotone machine learning model, and in directly calculating the grouped Shapley values, the instructions, when executed may further cause the processor 104 to perform the following: implementing only negative (i.e., beneficial) or positive (i.e., adverse) contributions for the monotone model, but the disclosure is not limited thereto.

According to exemplary embodiments, the processor 104 may build the monotone model in a manner such that every feature in the model is either positively monotone or negatively monotone, wherein a feature is positively monotone if an increment of a feature, while keeping all other features constant, always gives rise to an output that is greater or equal to that obtained without increasing the feature, and wherein a feature is negatively monotone if an increment of a feature, while keeping all other features constant, always gives rise to an output that is lesser or equal to that obtained without increasing the feature.

According to exemplary embodiments, in directly calculating the grouped Shapley values, the instructions, when executed may further cause the processor 104 to perform the following: maintaining links between features within the same reason code, thereby keeping track of which features are in each reason code (i.e., group of features) for which computation of importance in a mathematically sound way is performed.

According to exemplary embodiments, the instructions, when executed may further cause the processor 104 to perform the following: implementing an algorithm to correctly account for interaction effects of the groups of related features; and identifying the most important reason code based on the correctly accounted interaction effects among features in the reason codes.

According to exemplary embodiments, the processor 104 may implement the following mathematical formula predefined mathematical algorithm:

$${ϕ}_{j} = {\sum }_{S ⊆ C \backslash {R}_{j}} \frac{\vert S \vert ! ( m - \vert S \vert - 1 ) !}{m !} ( v ( {⋃}_{R ∈ S ⋃ {R}_{j}} R ) - v ( {⋃}_{R ∈ S} R ) ) ,$$

where ϕⱼ represents Shapley values (i.e., the importance) for a group of features Rⱼ corresponding to reason code j, m represents the number of reason codes (i.e., the number of groups of features for which we want to compute the importance), C={R₁, . . . , Rₘ} represents the set of groups of features corresponding to reason codes 1, . . . , m, and v: 2^{N}→ [symbol] represents a characteristic function. The characteristics function v(S) takes as input a set of the features S and returns an estimation of the output of the model when the features not in S are missing. N={1, . . . , n} is the set of features of model f and n represents the number of the features of model f. Our framework to compute grouped Shapley values is agnostic to the choice of characteristics function.

According to exemplary embodiments as disclosed above in FIGS. 1-5, technical improvements effected by the instant disclosure may include a platform for implementing a platform and language agnostic grouped Shapley values generating module for automatically computing grouped Shapley values whose directions (positive/negative) and values correctly evaluating the contribution of a reason code to the output of a machine learning model, accounting for interactions between features, but the disclosure is not limited thereto. For example, according to exemplary embodiments as disclosed above in FIGS. 1-5, technical improvements effected by the instant disclosure may include a platform for implementing a platform and language agnostic grouped Shapley values generating module reducing the out-of-manifold evaluations of SHAP when features in the same group are highly correlated. In addition, the language and platform agnostic grouped Shapley values generating module may be further configured to report the impact only of features with an adverse impact on the model output, or vice versa, the impact of only features with a beneficial impact on the model output, but the disclosure is not limited thereto.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for computing grouped Shapley values for action reason codes by utilizing one or more processors along with allocated memory, the method comprising:
utilizing a machine learning model that is configured to output decision data;
accessing a database that stores the outputted decision data and data corresponding to groups of related features;
establishing a communication link between the machine learning model and the database;
directly calculating grouped Shapley values that represent mathematically justifiable measure of importance for the groups of related features by implementing a predefined mathematical algorithm; and
outputting reason codes based on the computed grouped Shapley values.

2. The method according to claim 1, wherein the machine learning model is a tree-based non-linear machine learning model, and wherein in directly calculating the grouped Shapley values, the method further comprising:
calculating importances of groups of features in polynomial time for the tree-based non-linear machine learning model.

3. The method according to claim 1, wherein the machine learning model is a monotone machine learning model, and wherein in directly calculating the grouped Shapley values, the method further comprising:
implementing only positive or negative contributions for the monotone model.

4. The method according to claim 3, wherein the monotone model built in a manner such that every feature in the model is either positively monotone or negatively monotone.

5. The method according to claim 4, wherein a feature is positively monotone if an increment of a feature, while keeping all other features constant, always gives rise to an output that is greater or equal to that obtained without increasing the feature.

6. The method according to claim 4, wherein a feature is negatively monotone if an increment of a feature, while keeping all other features constant, always gives rise to an output that is lesser or equal to that obtained without increasing the feature.

7. The method according to claim 1, wherein in directly calculating the grouped Shapley values, the method further comprising:
maintaining links between features within the same reason code.

8. The method according to claim 1, further comprising:
implementing an algorithm to correctly account for interaction effects of the groups of related features; and
identifying the most important reason code based on the correctly accounted interaction effects among features of the reason codes.

9. The method according to claim 1, wherein the predefined mathematical algorithm utilizes the following mathematical formula:
$${ϕ}_{j} = {\sum }_{S ⊆ C \backslash {R}_{j}} \frac{\vert S \vert ! ( m - \vert S \vert - 1 ) !}{m !} ( v ( {⋃}_{R ∈ S ⋃ {R}_{j}} R ) - v ( {⋃}_{R ∈ S} R ) ) ,$$
where ϕⱼ represents Shapley values for a group of features Rⱼ, m represents reason codes, C={R₁, . . . , Rₘ} represents corresponding set of groups of features corresponding to reason codes, and v represents characteristic function.

10. A system for computing grouped Shapley values for action reason codes, the system comprising:
a processor; and
a memory operatively connected to the processor via a communication interface, the memory storing computer readable instructions, when executed, causes the processor to:
utilize a machine learning model that is configured to output decision data;
access a database that stores the outputted decision data and data corresponding to groups of related features;
establish a communication link between the machine learning model and the database;
directly calculate grouped Shapley values that represent mathematically justifiable measure of importance for the groups of related features by implementing a predefined mathematical algorithm; and
output reason codes based on the computed grouped Shapley values.

11. The system according to claim 10, wherein the machine learning model is a tree-based non-linear machine learning model, and in directly calculating the grouped Shapley values, the processor is further configured to:
calculate importances of groups of features in polynomial time for the tree-based non-linear machine learning model.

12. The system according to claim 10, wherein the machine learning model is a monotone machine learning model, and in directly calculating the grouped Shapley values, the processor is further configured to:
implement only positive or negative contributions for the monotone model.

13. The system according to claim 12, wherein the monotone model built in a manner such that every feature in the model is either positively monotone or negatively monotone.

14. The system according to claim 13, wherein a feature is positively monotone if an increment of a feature, while keeping all other features constant, always gives rise to an output that is greater or equal to that obtained without increasing the feature.

15. The system according to claim 13, wherein a feature is negatively monotone if an increment of a feature, while keeping all other features constant, always gives rise to an output that is lesser or equal to that obtained without increasing the feature.

16. The system according to claim 10, in directly calculating the grouped Shapley values, the processor is further configured to:
maintain links between features within the same reason code.

17. The system according to claim 10, wherein the processor is further configured to:
implement an algorithm to correctly account for interaction effects of the groups of related features; and
identify the most important reason code based on the correctly accounted interaction effects among features of the reason codes.

18. The system according to claim 10, wherein the predefined mathematical algorithm utilizes the following mathematical formula:
$${ϕ}_{j} = {\sum }_{S ⊆ C \backslash {R}_{j}} \frac{\vert S \vert ! ( m - \vert S \vert - 1 ) !}{m !} ( v ( {⋃}_{R ∈ S ⋃ {R}_{j}} R ) - v ( {⋃}_{R ∈ S} R ) ) ,$$
where ϕⱼ represents Shapley values for a group of features Rⱼ, m represents reason codes, C={R₁, . . . , Rₘ} represents corresponding set of groups of features corresponding to reason codes, and v represents characteristic function.

19. A non-transitory computer readable medium configured to store instructions for computing grouped Shapley values for action reason codes, wherein, when executed, the instructions cause a processor to perform the following:
utilizing a machine learning model that is configured to output decision data;
accessing a database that stores the outputted decision data and data corresponding to groups of related features;
establishing a communication link between the machine learning model and the database;
directly calculating grouped Shapley values that represent mathematically justifiable measure of importance for the groups of related features by implementing a predefined mathematical algorithm; and
outputting reason codes based on the computed grouped Shapley values.

20. The non-transitory computer readable medium according to claim 19, wherein the machine learning model is a tree-based non-linear machine learning model, and in directly calculating the grouped Shapley values, the instructions, when executed, cause the processor to further perform the following:
calculating importances of groups of features in polynomial time for the tree-based non-linear machine learning model.
